(19) United States
(12) Patent Application Publication
(10) Pub. No.: US 2022/0001277 A1
(43) Pub. Date: Jan. 6, 2022

(54) SYSTEMS AND METHODS FOR PEER TO PEER VIDEO GAME STREAMING

(71) Applicant: Scott BARNES, Austin, TX (US)

(72) Inventor: Scott BARNES, Austin, TX (US)

(21) Appl. No.: 17/366,742

(22) Filed: Jul. 2, 2021

Related U.S. Application Data
(60) Provisional application No. 63/047,390, filed on Jul. 2, 2020.

(51) Int. Cl. A63F 13/34; H04L 29/06

(52) U.S. Cl. CPC A63F 13/34; H04L 65/403; H04L 65/1069

(57) ABSTRACT

Systems and methods for streaming of a video game process executing on the streaming source device, whose graphics and audio are captured and transmitted over the network connection to a streaming sink device, which renders and plays them for consumption by the user. The streaming sink device captures the user's inputs and transmits them over the peer to peer network connection to the streaming sink device, which sends them to the video game process. These processes allow the user to see, hear, and interact with the video game session from the streaming sink device, even though the video game process is executed on the streaming source device.

### CROSS-REFERENCE TO RELATED APPLICATIONS

This application claims the benefit of priority to U.S. provisional patent application No. 63/047,390 entitled “Systems and Methods for Peer to Peer Video Game Streaming” filed on Jul. 2, 2020, the entirety of which is incorporated by reference herein.

### TECHNICAL FIELD

The present invention relates to the capture and streaming of a video game session over a peer to peer connection. More specifically, the present invention relates to the facilitation of a network connection between peer devices, over which the video and audio generated by a video game process on one device, and inputs generated by a user on another device, are transmitted between devices.

### BACKGROUND OF THE INVENTION

Internet-based video game play is a growing hobby for people across the world. Advances in processing power and network infrastructure have given rise to on-demand video game services and even e-sports leagues consisting of competitive online video game play. Online video game hosting services use game host servers to provide users with on-demand access to a variety of video game play options. Despite improvements in computer and networking technology, growth of the video game industry continues to push bandwidth limitations and network resources. By providing a number of host server options to users, video game services can reduce the likelihood that online game play will be “glitchy”, lagged, or otherwise difficult for users to enjoy.

### BRIEF SUMMARY

Embodiments of the invention allow for the performance of video game session streaming over a peer to peer network. So long as user computing devices have a network connection that enables them to directly connect to one another, a video game session can be streamed according to the various embodiments.

One embodiment of the invention is directed to a method of remote play of a video game session over a peer to peer network. The method may include transmitting, via a communications interface, a connection request message to a connection node; and in return, receiving a list of available streaming source devices and the video games each available streaming source device can stream. The method also includes transmitting, via the communications interface, a second connection request message indicating a streaming source device selection and a video game selection, and receiving connection information for the selected streaming source device. Further, the method may include connecting, via the communications interface, to the selected streaming source device via a peer to peer network connection. The method may include receiving, via the communications interface, video data and audio data in a data stream from the selected streaming source device, and then rendering by the display and the speaker, the video data and the audio data as part of a video game session for the selected video game.

Additional embodiments include a user computing device comprising a processor, a communications interface, a display, an input device, and a speaker, and a computer readable medium or memory. The computer readable medium or memory comprises code, executable by the processor, configured or programmed to perform the above-noted method.

Another embodiment of the invention is directed to a method of streaming a video game session over a peer to peer network. The method may include transmitting, via the communications interface, a game host request message to a connection node, wherein the game host message includes identifiers of video games the streaming source device can stream; and in return, receiving, via the communications interface, from the connection node, connection information for a streaming sink device. The method may also include connecting, via the communications interface, directly to the streaming sink device, based on the connection information received from the connection node; and receiving, via the communications interface, a game launch request from the streaming sink device, wherein the game launch request indicates an identifier for one of the video games the streaming source device can stream. The method includes executing, by the processor, a video game process corresponding to the identifier in the game launch request; and transmitting, via the communications interface, to the streaming sink device, video data and audio data of the video game process.

Additional embodiments include a user computing device comprising a processor, a communications interface, and a computer readable medium or memory. The computer readable medium or memory comprises code, executable by the processor, configured or programmed to perform the above-noted method.

### BRIEF DESCRIPTION OF THE DRAWINGS

Various other features and attendant advantages of the present invention will be more fully appreciated when considered in conjunction with the accompanying drawings.

FIG. 1 is a block diagram illustrating a network environment including a connection node, over which a peer to peer connection may be established for providing a video game streaming service according to the various embodiments

FIG. 2 is a block diagram illustrating a system for remote play of a video game over the peer-to-peer network according to the various embodiments.

FIGS. 3A-B shows a block diagram illustrating a network connection between two peer devices in a peer to peer network, over which a video game session may be streamed according to the various embodiments.

FIGS. 4A-B show a block diagram illustrating the streaming of a video game session over a peer to peer network connection according to the disclosed embodiments.

FIGS. 5A-C show a process flow diagram illustrates an exemplary method of peer-to-peer video game streaming according to the various embodiments.

FIG. 6 shows a block diagram illustrating a connection node of a peer to peer network according to an embodiment of the invention.

FIG. 7 shows a process flow diagram of an exemplary method of hosting a streamed video game session by a streaming source device according to an embodiment of the invention.

FIG. 8 shows a process flow diagram of an exemplary method of playing a streamed video game session over a peer to peer network device according to an embodiment of the invention.

### DETAILED DESCRIPTION OF THE INVENTION

Prior to discussing embodiments of the invention, some terms can be described in further detail.

A “processor” may refer to any suitable data computation device or devices. A processor may comprise one or more microprocessors working together to accomplish a desired function. The processor may include a CPU comprising at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

A “transceiver” may be a computing device component capable of transmitting and receiving information via a transmission medium. The transmission medium may include wired or wireless communications. For example, transceivers in cellular phone or cellular-enabled mobile devices may enable information exchange over a variety of wireless communications protocols.

A “user computing device” may be any suitable device that can interact with a user. A user computing device may communicate over a network with other user computing devices. The network may include the Internet, a local area network, a wide area network, and/or a peer to peer network. User devices may be in any suitable form. Some examples of user devices include POS devices, cellular phones, PDAs, personal computers (PCs), video game consoles, tablet PCs, wearable devices (e.g. head mounted displays), vehicles with communication capabilities (e.g., smart cars), etc.

A “user” may include an individual. In some embodiments, a user may be associated with one or more personal accounts and/or user devices. A user may have accounts with a peer-to-peer gaming network service.

A “video game” may include a software game played on a computing device. A video game may be played by electronically manipulating images produced by a computer program on a display screen. User input may be received by an input device to guide or manipulate changes to the audiovisual output of the display screen as part of a video game process. A variety of video games may be played on a user computing device.

“Streaming” may refer to the practice of delivering multimedia data in a continuous or semi-continuous data stream with little or no intermediate storage in network components. Streaming refers to the transmission and receipt method of multimedia data and not the data itself. Streaming may include content buffering to improve the quality of received multimedia data. By streaming multimedia data from a source, a user computing device may open, execute, or otherwise access the multimedia content of the data before all data associated with the content is received and assembled.

A “peer to peer network” may include a network or networking environment that has distributed application architecture that partitions tasks between computing device peers. Peers are equally privileged, equipotent participants in the application. They are said to form a peer-to-peer network of nodes. Peers make a portion of their resources, such as processing power, disk storage or network bandwidth, directly available to other network participants, without the need for central coordination by servers or stable hosts. Peers may exist as both suppliers and consumers of network and data resources.

A “connection node” may include a network-connected computing device, server computer or a series of server computers that are configured to communicate with various user computing devices and other application nodes via a network. The connection server may communicate with the user computing devices using over-the-air (OTA) messages or using any other communication networks and protocols. For example, the connection node may be configured to provide a communications channel with a device over which information can be transmitted securely to and from the device using a communications network, the Internet, and/or any other relevant communications network. The connection server may support and enable the provision of a peer to peer network by providing access to a connection service software application supporting or enabling a peer to peer network. The connection node may be a video game server or video game system or the like.

A “streaming sink device” may include user computing devices receiving multimedia data via a peer to peer network connection with another user computing device.

A “streaming source device” may include user computing devices transmitting multimedia data via a peer to peer network connection with another user computing device.

A “game launch request” may include an electronic transmission including data packets indicating a request to indicate transmission of video game data streaming to the requesting device from one or more peers in a peer to peer network.

The disclosed embodiments include the establishment of a peer to peer network to enable the streaming of a video game session between a pair of peer devices over a network connection, such that the user may see, hear, and interact with the video game session from a different user computing device than the device performing the execution of the video game process. A connection node may be configured by the connection service software to accept and maintain network connections from streaming source devices and streaming sink devices. Streaming source devices, which are associated with a user account and a unique ID, create a network connection with the connection node and advertise their availability to host a video game session to the network. Upon notification of a request to host a video game session by a streaming sink device, the streaming source device creates a network connection to the streaming sink device. The streaming source device then executes a video game process, captures and transmits, over the network connection to the streaming sink device, the video and audio data generated by the video game process. Simultaneously, the streaming source device receives from the streaming sink device user input data over the network connection, which are transmitted to the video game process.

The streaming sink devices, each of which may be associated with a user account, receive a list of available streaming source devices available for streaming a video game session within in the peer to peer network. Upon selection of a streaming source device by the user of a streaming sink device, the streaming sink device creates a network connection with the connection node, and subsequently creates a network connection to the selected streaming source device. The streaming sink device then executes streaming sink software to capture and transmit user input to the connected streaming source device over the network connection, as well as receiving over the network connection the multimedia data, e.g., video and audio, from the connected streaming source device. The received multimedia data may be rendered and played for the user to consume. In some embodiments, the streaming sink device may form a network connection with multiple streaming source devices to further distribute the data transmission load across peer devices.

Various embodiments may address problems related to maintaining audiovisual quality during streaming video game sessions. Video game streaming platforms have increased in popularity leading to large numbers of users engaging in video game streaming sessions at the same time. The demands on bandwidth created by simultaneous streaming sessions often result in latency (delayed packet delivery) or lag and dropped packets. Users of the video game streaming service experience this lag or latency as missing pixels in a displayed video frame; frozen, delayed, or skipping movement between frames; skipped audio; missing audio segments; or the like.

To address these issues, the various embodiments provide systems and methods that distribute the demand on network resources across participating user computing devices. Specifically, user computing devices may subscribe to and participate in a peer to peer video game streaming network, which enables the distribution of streaming session resources across peer devices to alleviate the load demand on a central server. A requesting user computing device may transmit a game launch request to a connection server, which may initiate the game launch and connect the requesting user computing device, i.e. a streaming sink device, to one or more peers, i.e., streaming source devices that stream at least a portion of a video game session to the streaming sink device. This architecture places the server in the position of hosting a streaming service software application and brokering connections between peers rather than providing the entirety of the streaming. Peer devices that are sleeping or not currently utilizing their processing and networking resources are tasked with streaming video game data to and from the device, the streaming source device and to a streaming sink device. By leveraging alternative hosts for video game streaming sessions, the peer to peer network may reduce the likelihood of latency and dropped packets during video game streaming sessions.

The advantages of the various embodiments are described in greater detail with reference to the figures. The peer to peer video game streaming system reduces latency and dropped packets during a video game streaming session by utilizing unused network resources of peer devices.

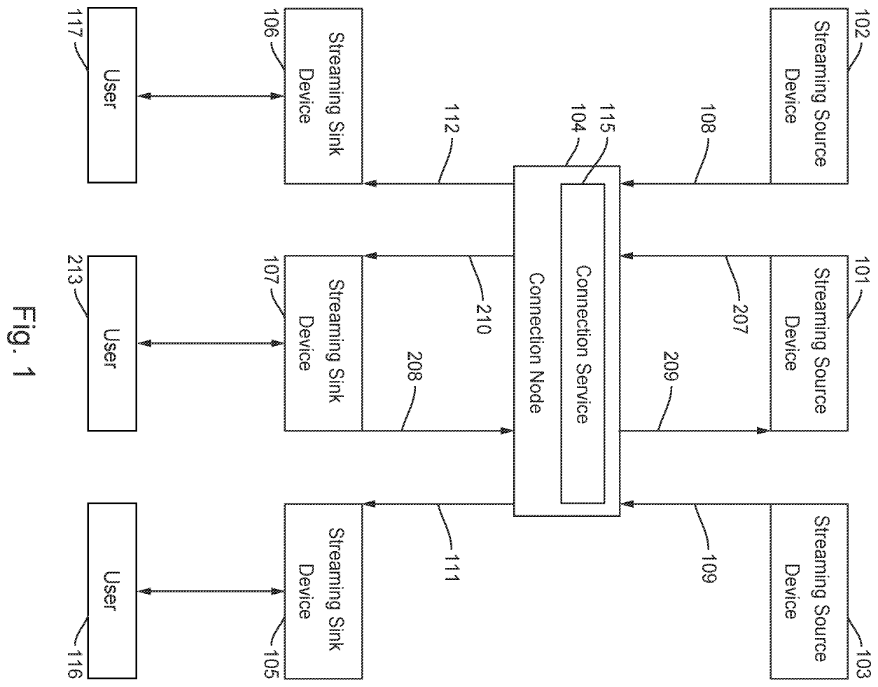

Referring to FIG. 1, there is shown a network environment including user computing devices serving as peer devices in a peer to peer network. The various user computing devices may be configured as streaming source devices 101, 102, 103, and other user computing devices configured as streaming sink devices 105, 106, 107. The various user computing devices may switch roles within the peer to peer network according to the needs of users. That is, a user computing device may be a streaming source device 103 until a user is ready to play a video game. The streaming source device 103 may then cease streaming a video game session an may instead become a streaming sink device 105, initiating a request to connect to a streaming source device 101, 102. The user computing devices may thus serve as either one or of both streaming sink devices and streaming source devices as needed.

Each streaming source device 101, 102, 103 creates a connection 108, 109, 207 to a connection service 115 generated by streaming source software 201, which is software executed on a connection node 104. The connection service 115 may identify available streaming source devices 101, 102, 103 and may provide the requesting streaming sink device with connection port and network address information for one or more streaming source devices 101, 102, 103. Thus, the connection node 104 receives connection requests and matches them with available streaming source devices to enable transmission of video game session data between a streaming source device 101, 102,103 and a streaming sink device 105, 106, 107, but does not itself, transmit video game session data, e.g. multimedia data.

Upon connecting with the connection node 104, each streaming source device 101, 102, 103 advertises its ability to host a video game session, and provides a list of video games it is capable of hosting in that session. A software application executing on the streaming source device 101, 102, 103 may transmit this information in a game host request message to the connection service 115 of the connection node 104. The connection service 115 uses the provided host availability information and the video game capabilities information to match the streaming source device 101, 112 103 with a streaming sink device 105, 106, 107 requesting to play one of the video games indicated in the game host request message.

Each streaming sink device 105, 106, 107, upon request by a user 116, 117, 213 operating the device, connects to the connection service. The connection service 115 transmits a list of the available streaming source devices. The connection service 115 may also transmit a list of the games that can be hosted by those streaming source devices. The list of available streaming source devices and the list of video games that can be hosted on each of the devices may be displayed on a requesting streaming sink device; 105, 106, 107. A user 116, 117, 213 may use one or more user input devices associated with a streaming sink device 105, 106, 107 to select an available streaming source device 101, 102, 103 and an available video game. In other embodiments, the streaming sink device 105, 106, 107 may display the list of available video games first and upon receipt of a user selection, may then display the list of available streaming source devices 101, 102, 103 that can host a video game session of the selected video game.

Upon the selection by the user 116, 117, 213 of a video game to play and a streaming source device 101, 102, 103, the streaming sink device 101, 102, 103 sends a game launch request to the connection service 115. The transmission of the game launch request initiates the process of establishing a peer to peer connection between the streaming sink device 105, 106, 107 and the target streaming source device 101, 102, 103. Streaming of multimedia data for a video game session then begins from the streaming source device 101, 102, 103 to a streaming sink device 105, 106, 107.

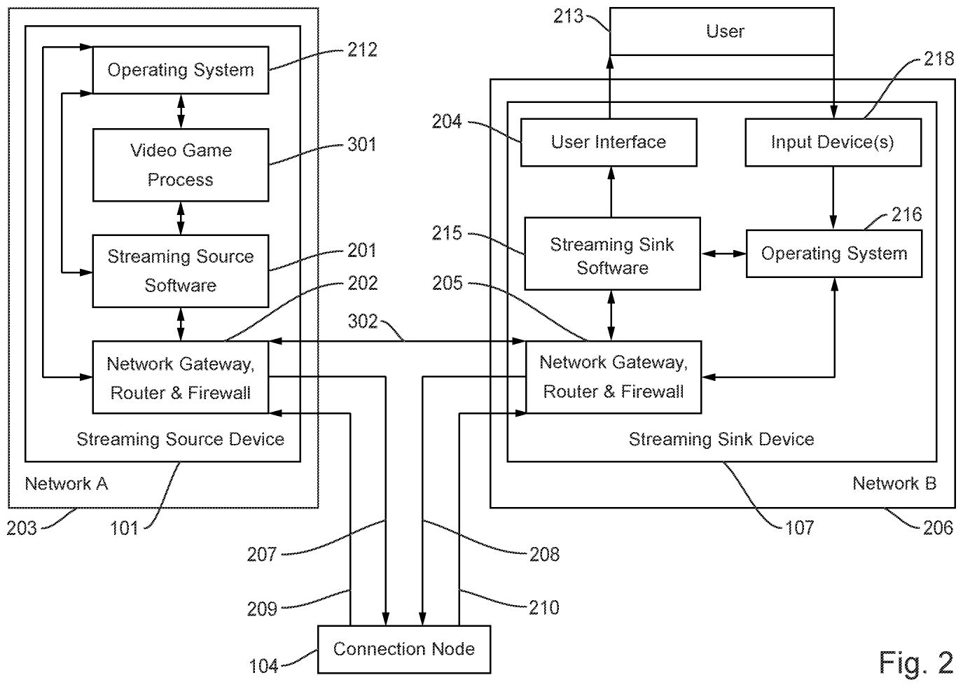

With reference to FIG. 2, a network connection 302 is shown between two peer devices in a peer to peer network, over which a video game session may be streamed. With reference to FIGS. 1-2, the peer to peer connection 302 is facilitated and managed by a streaming source software 201 executing on a streaming source device 101, and a streaming sink software 215 executing on a streaming sink device 107, both of which are members of the peer to peer network depicted in FIG. 1. In one configuration, the streaming source device 101 and streaming sink device 107 are on different subnetworks, network A 203 and network B 206 respectively. These subnetworks may be configured with a network gateway/router and firewall 202, 205 which is configured to allow outgoing connections to the Internet. However, these subnetworks may refuse incoming data traffic that is not associated with an active outbound connection created by a device on that network. An implementation example of this network configuration is Network Address Translation (NAT), which maps the private IP addresses of user computing devices within the network gateway/router's network to a random port on the public IP address owned by the network gateway/router.

In this example configuration, the streaming source device 101 and streaming sink device 107 may not create a direct connection with each other, as the network gateway/router would drop any unsolicited incoming traffic. The connection node 104 facilitates a connection between user computing devices (i.e., peers) by re-using the network connection that the user computing devices use to connect to the connection node. Because an active, outgoing connection exists, incoming traffic to each user computing device at the IP address and port associated with that connection will be accepted.

In this exemplary configuration in FIG. 2, the streaming source device 101 and streaming sink device 107 have a network connection with the network gateway/router 202, 205 over one or more network protocols such as Ethernet or Wi-Fi. In other configurations, the devices may connect to the Internet using other network mechanisms, such as 4G, 5G, 5G NR, or another mobile network data protocol.

The streaming source software 201 transmits a network join request 207 over the Internet to the connection node 104. This network join request 207 may include user credentials or token to enable authentication of the streaming source device 101. The connection service 115 may authenticate the user of the streaming source device using a user account credentials or token such as a password, username, certificate, etc., which may be stored in the streaming source device or entered at the time of the request. If the streaming source device is authenticated, the connection node 104 accepts the network join request and maintains an open network connection with the streaming source software 201 and the streaming source device becomes part of the peer to peer network.

When a user 213 operates input device(s) 218 to initiate a video game session via a user interface 204, the streaming sink software 215 fetches a list of available video games and active streaming source devices 101, 102, 103 available for hosting a video game session from the connection mode 104. The list of available video games and/or the list of available streaming source devices may be displayed on the user interface 204 for review by the user 213. The user 213 may select one of the video games from the list and an available streaming source device, via input device(s) 218. Upon selection by the user 213, the streaming sink software 215 transmits a connection request 208 over an Internet connection to the connection node 104. The connection request 208 may include specifying the unique ID associated with the selected streaming source device 101. The streaming sink device 107 may include authentication information in the connection request 208. The authentication information may include user name, password, certificate, or other credentials or token that may be used to authenticate the user 213 of the streaming sink device 107. The connection service 115 may authenticate the user 213 using the provided token or credentials. If the streaming sink device 107 is authenticated and authorized to access the requested streaming source device 101, the connection node 104 accepts the connection request 208.

The connection node 104 transmits the network connection information 210 of the streaming source software 201 executing on the streaming source device 101 to the streaming sink software 215 executing on the streaming sink device 107. The connection node 104 also transmits the network connection information 209 of the streaming sink software 215 executing on the streaming sink device 107 to the streaming source software 201 executing on the streaming source device 101. The network connection information may include the IP address and port of the network connection associated with the software on the device. The network connection information may also include device ID for each connecting device.

The streaming source software 201 transmits a connection request 207 over the Internet to the streaming sink software 215. The streaming sink software 215 transmits a connection request 208 over the Internet to the streaming source software 201, using the network connection information provided by the connection node 104. If the user session associated with each request is authenticated and authorized for the respective devices, the requests are accepted by the software executing on those devices. A peer to peer network connection 302 is established between the streaming source software 201 and the streaming sink software 215. The streaming source device 101 and streaming sink device 107 may have no further communication with the connection node 104 for the duration of the video game session.

Embodiments illustrated in FIG. 2. show a single streaming source device 101 and a single streaming sink device 107. However, in various embodiments, there may be many of each type of user computing device connecting to the connection node 104 and joining the peer to peer network. The connection node 104 maintains an open connection with each authenticated streaming source device 101, 102, 103, and facilitates a connection between connecting streaming sink devices and a streaming source device matching the unique ID in the connection request that the user is authorized to access. In other embodiments, each streaming sink device 107 may only connect to one streaming source device 101 at a time.

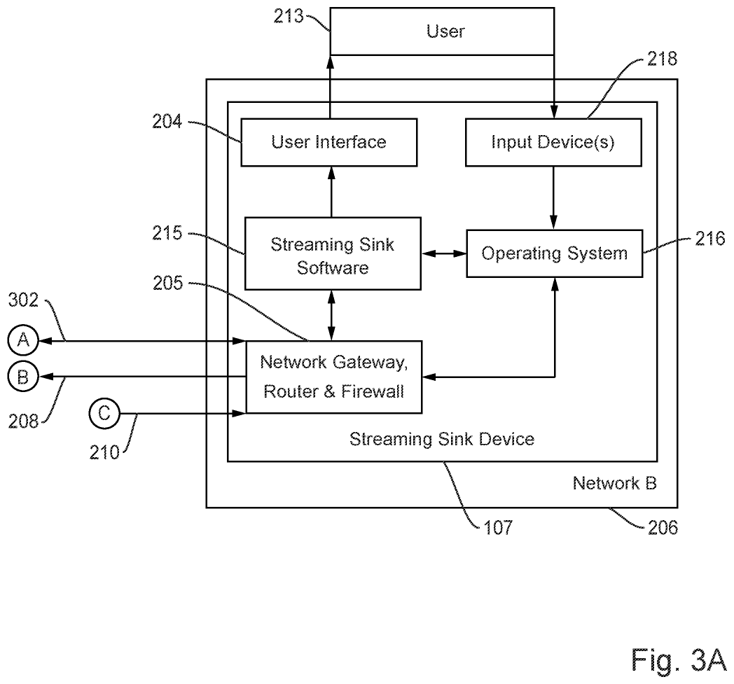

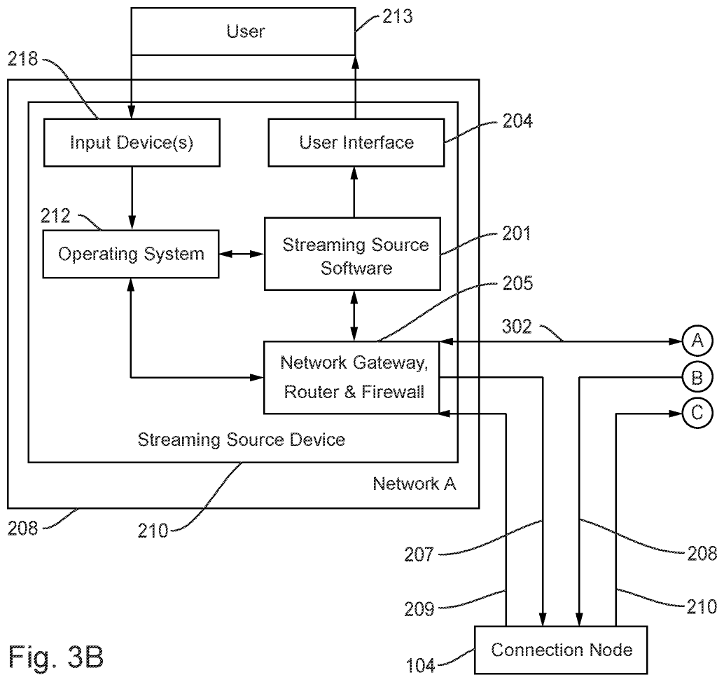

Referring to FIGS. 3A and 3B, a system for remote play of a video game over the peer to peer network is illustrated. With reference to FIGS. 1-3B, the system providing video game streaming over the peer to peer connection is established as described in greater detail with reference to FIG. 2. Once the connection 302 is established, the streaming source software 201 starts the execution of a video game process 301 on the streaming source device 101. The video game process 301 corresponds to the video game selected by the user 213 and transmitted in the connection request.

A processor of the streaming source device 101 executing the video game process 301 generates video, i.e. picture and video, and audio data associated with the selected video game. This multimedia data, i.e. video game session data, is captured by the streaming source software 201, transmitted over the peer to peer connection 302, and received by a transceiver of the streaming sink device 107. The processor of the streaming sink device 107 may pass the multimedia data to the streaming sink software 215 for reassembly and integration into a video game executing on the device. In this manner, the multimedia data used to play the video game executing on the streaming sink device 107 is generated and transmitted in a continuous data stream from the streaming source device 101.

The user 213 can view and listen to the multimedia data via the user interface 204 of the streaming sink device 107. During play of the video game on the streaming sink device 107, the user 213 provides input to the streaming sink device via one or more input device(s) 218, such as a touch screen, keyboard, video game controller, joystick, or mouse. User inputs via the input device(s) 218 are captured by the processor and passed to the streaming sink software 215. The streaming sink software 215 may instruct the transceiver of the streaming sink device 107 to transmit the user input to the streaming source device 101. A transceiver of the streaming source device 101 may receive the user input data and pass it to the video game process 301 on the streaming source device 101.

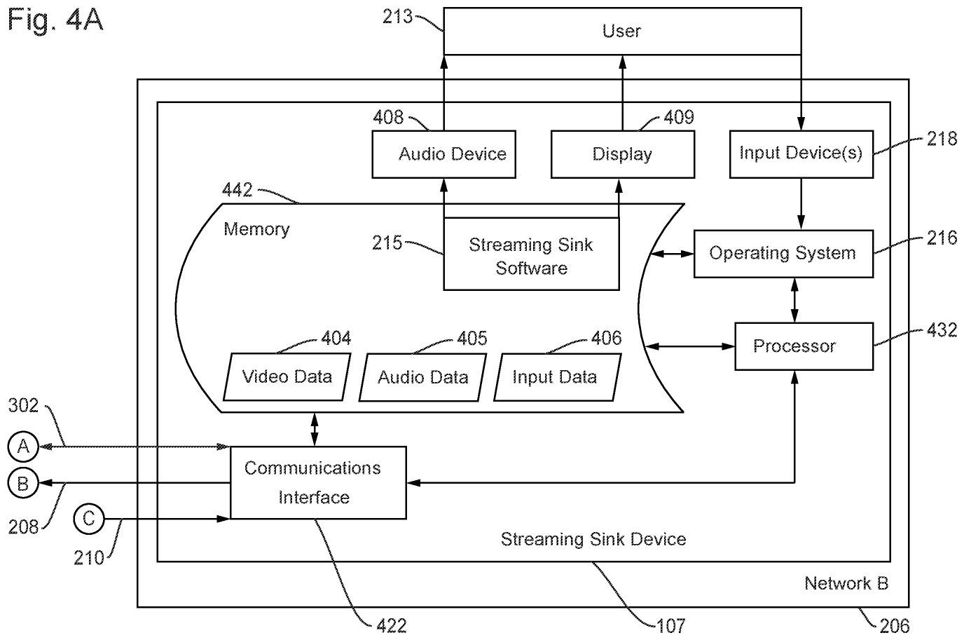

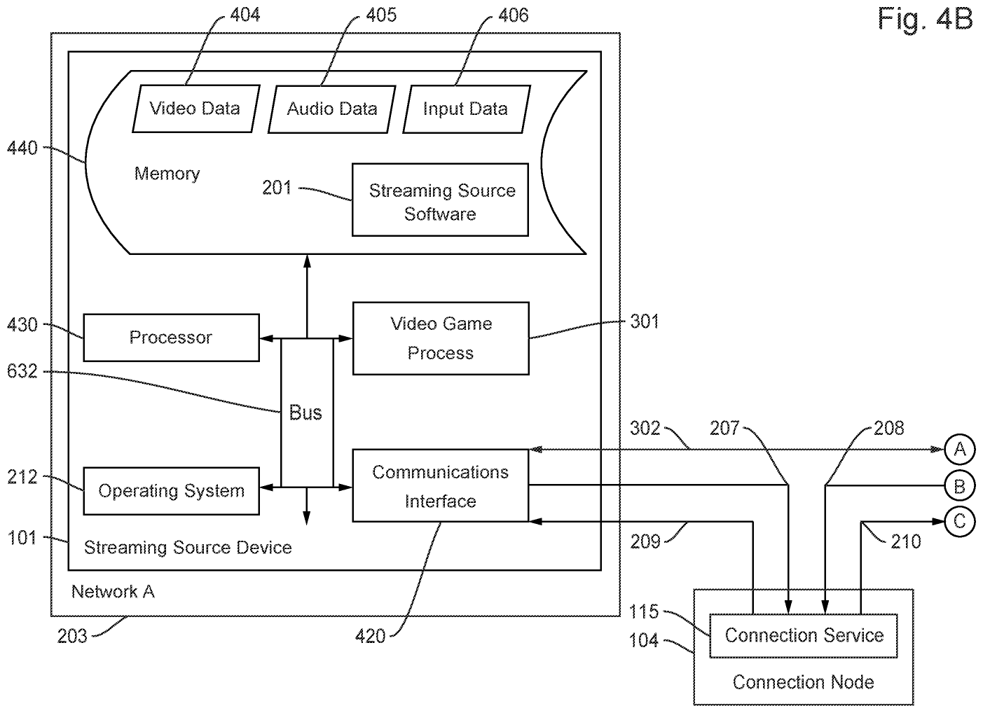

Referring to FIGS. 4A and 4B, which illustrates the streaming of a video game session over a peer to peer network connection according to an embodiment. With reference to FIGS. 1-4B, the various hardware and software components of the user computing devices may facilitate the remote play of a video game between a streaming source device 101 executing a video game process 301, and a streaming sink device 107. Through the streaming sink device 107, the user 213 may interact with the video game process 301 over a peer to peer network connection 302 without requiring proximity to the device executing the video game process 301, i.e. the streaming source device 101.

With reference to FIG. 4A, the user computing devices, i.e. peer devices, generally, each user computing device includes one or more processor(s) 430, 432 (e.g., ASICs, digital signal processors (DSPs), etc.). That is, the processors 430, 432 can be implemented as one or more integrated circuits (e.g., one or more single core or multicore microprocessors and/or microcontrollers), and is used to control the operation of the user computing devices. The processors 430, 432 can execute a variety of programs in response to program code or computer-readable code stored in the system memory 440, 442.

The memory 440, 442 can be implemented using any combination of any number of non-volatile memories (e.g., flash memory) and volatile memories (e.g. DRAM, SRAM), EEPROM, or any other non-transitory storage medium, or a combination thereof media. Memory 440, 442 may store an operating system 212, 215 and an application environment where one or more software applications reside (e.g. streaming sink software 215, etc.) to be executed by a processor 430, 432. Also, the memory 440, 442 may store computer code, executable by the processor 430, 432, for performing any of the functions described herein. Further, memory 440, 442 may include partitions, or other sections of secure storage accessible only by applications operating on the secure memory. That is, applications without permissions to access the secure memory may not gain access to store, maintain, or manage data therein.

The user computing devices also include one or more input/output (I/O) interfaces (e.g., user interface 204). These I/O interfaces include input device(s) 218, audio device 408, and display 409. Example I/O interfaces may include a keyboard and mouse, a touchscreen, a joystick, a game controller, a trackpad, a microphone, speakers, and one or more buttons (e.g., volume or power buttons, etc.), which may be integrated into a display 409. The various components of the user computing devices may be communicatively coupled via the system's bus.

The user computing devices further includes one or more communications interfaces 420, 422 which may be wireless and or hard wired. In an example embodiment, if made part of the user computing device, a wired component of communication interface 420, 422 may be used to support wired local connections to peripheral devices (e.g., a USB connection, a mini USB or lightning connection, a headphone jack, video ports such as serial, VGA, HDMI, DVI or DisplayPort, audio ports, and so on) and/or to a wired access network (e.g., via an Ethernet cable or another type of cable that can function as a bridge to the wired access network such as HDMI v1.4 or higher, etc.). In another example embodiment, the wireless component of the communications interface 420, 422 includes one or more transceivers for communication in accordance with a local wireless communications protocol (e.g., WLAN or Wi-Fi, Wi-Fi Direct, Bluetooth, etc.) and/or one or more wireless transceivers for communication with a cellular RAN (e.g., via CDMA, W-CDMA, time division multiple access (TDMA), frequency division multiple access (FDMA), Orthogonal Frequency Division Multiplexing (OFDM), GSM, LTE, 4G, 5G LTE, 5G NR or other protocols that may be used in a terrestrial wireless communication subscriber network). In another example embodiment, the wireless component of the communication interface 420, 422 may include one or more transceivers for communicating with a navigation system such as a global positioning system (GPS).

The display 409 may be configured as a touchscreen display or monitor, and may be communicatively coupled to peripheral buttons such as a power control button, a volume or vibrate control button, an airplane mode toggle button, etc., and at least one front-panel button such as a home button, among other components. While not shown explicitly as part of the user 213 computing device, the display 409 can include one or more external antennas and/or one or more integrated antennas that are built into the external casing of the mobile communication device 102, including but not limited to Wi-Fi antennas, cellular antennas, satellite position system (SPS) antennas (e.g., global positioning system (GPS) antennas), and so on.

Reference is now made to the specific operations of user computing devices performing the functions of the streaming sink device 107 and the streaming source device 101.

A processor 430 of the streaming source device 101 executes code stored in memory 440 including the of the streaming source software 201 and the video game process 301 on the operating system 212. This operating system 212 may be software installed directly on the streaming source device 101 and stored in a storage 440, or it may be separated from the physical hardware of the streaming source device 101 via virtualization technology. Execution of the video game process 301 generates video data 404 and audio data 405 associated with the state of the video game process 301. The streaming source software 201 instructs the processor 430 to capture the multimedia data and prepare it for transmission. The video data 404 and audio data 405 are encoded by the processor 430 and transmitted by the communications interface 420 over the peer to peer network connection 302 to the streaming sink software 215 on the streaming sink device 107.

Similarly, the processor 432 of the streaming sink device 107 executes code stored in memory 442 including the streaming sink software 215 on the operating system 216. The communications interface 4222 of the streaming sink device 107 may receive video data 404 and audio data 405 from the streaming source device. This data is decoded by the processor 432 and passed to the streaming sink software 215. The received video data 404 is decoded and displayed to the user 213 via a display 409, such as a monitor or touchscreen, on or attached to the streaming sink device 107. The received audio data 405 is decoded and played for the user 213 via an audio device 408, such as speakers or headphones, on the streaming sink device 107.

On the streaming sink device 107, the user 213 provides inputs to the input device(s) 218, such as a keyboard, mouse, controller, joystick, or touchscreen, which are captured by the streaming sink software 215. The user input data 406 is passed from the input device(s) 218 the processor, 432, which encodes the input data 406 and prepares it for transmission. The input data 406 is transmitted by communication interface 422 to the streaming source device 101, which receives the input data via communication interface 420. The streaming source software 201 executing on the streaming source device 101 instructs the processor 430 to decode the input data 406 and pass it to the video game process 301.

The user 213 of the streaming sink device 107 is able to see, hear, and interact with the video game process 301 executing on the streaming sink device 101, via the streaming of multimedia data and input data 406 between the two peer devices. The streaming source device 101 and streaming sink device 107 do not need to be co-located in order to facilitate the remote play of video game sessions. So long as both devices have a connection to the internet with adequate bandwidth to transmit the requisite data, the process may execute successfully.

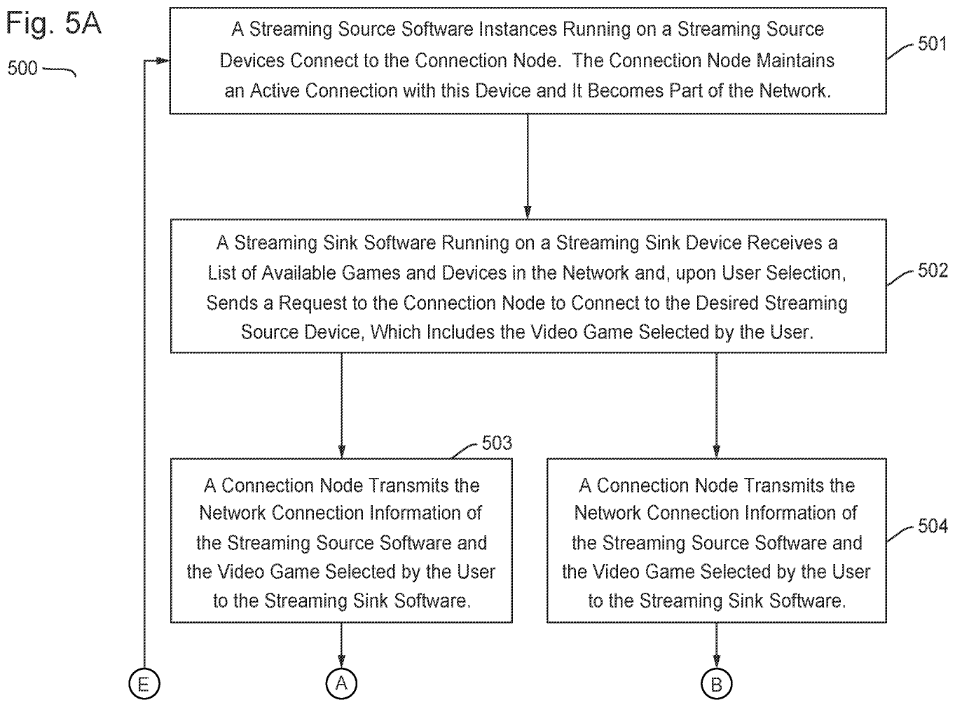

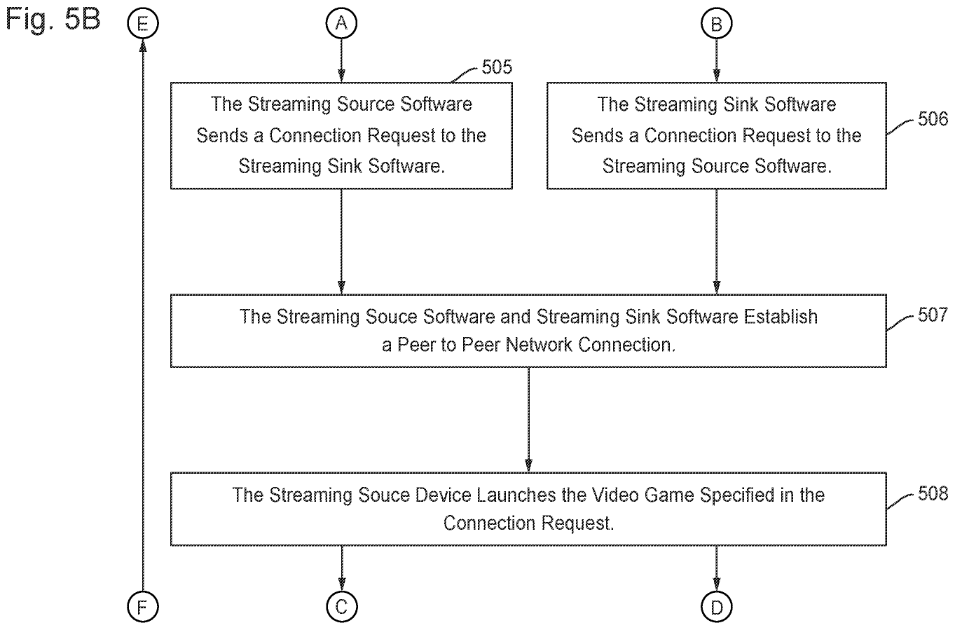

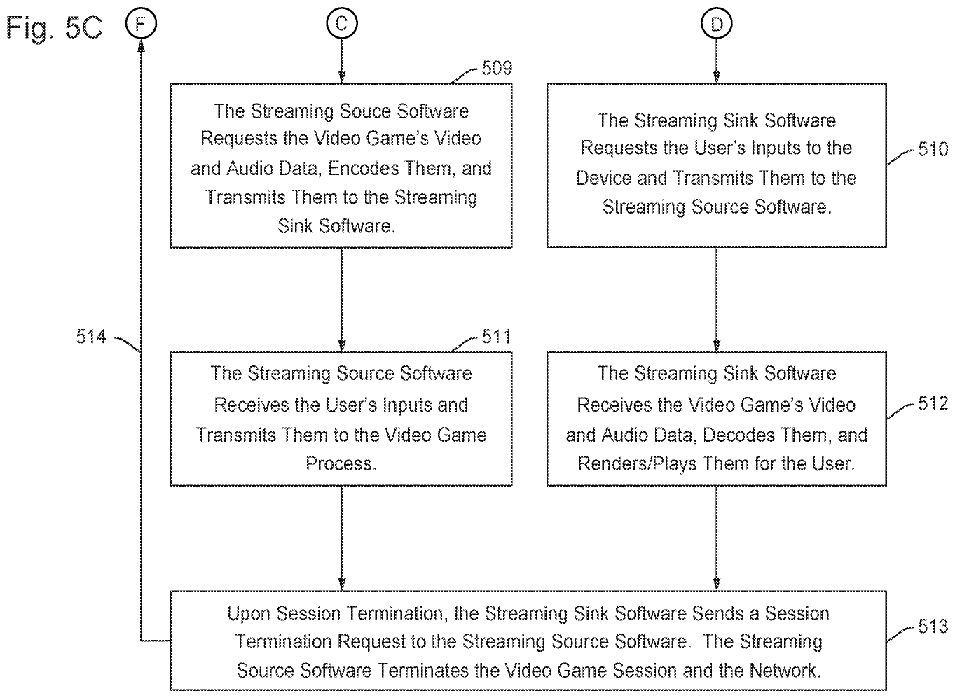

With reference to FIGS. 5A-C, an exemplary method of peer to peer video game streaming is illustrated. With reference to FIGS. 1-5C, a process for establishing a network connection between two user computing devices in the peer to peer network may enable the remote play of video games, the streaming of a video game session over the connection, and termination of that connection may describe with reference to method 500.

In step 501, the streaming source software 201 executed by processor 430 on the streaming source device 101 connects to the connection service 115 via the communication interface 420. For example, the streaming source software 201 may receive input from a user, or may be prompted by a stored timer, or sleep instruction to initiate a peer to peer connection with the connection service 115. In FIG. 4B, the streaming source device 101 may have an instruction stored in memory 440 that instructs the processor 430 to initiate a connection to the connection service 115 for hosting a video game session any time the streaming source device 101 has been dormant or in sleep mode for a predetermined amount of time.

The streaming source service 201 may generate a game host request message. The game host request message may be an electronic message consisting of data including connection port, IP address, unique ID of the streaming source device 101, and identifiers of video games the streaming source device can host. This message is encoded by the processor 430 and passed to the communication interface 420. The communication interface 420 may encode the game host request message and transmit the message in data packets via a communication protocol. A communication interface of the connection node 104 may receive and decode the game host request message.

The connection service 115 is software executed by a processor of the connection node 104. The connection service maintains an open network connection with the streaming source software 201 executing on the streaming source device 101, resulting in the streaming source device 101 becoming part of the peer to peer network.

In step 502, the streaming sink software 215 executed by the processor 432 of the streaming sink device 107 transmits a connection request 208 message to the connection service 115 to connect to the streaming source device 101, as selected by the user 213. That is, the user 213 provision of input via the input device(s) 218 may be a selection of a streaming source device 101 and a video game available for hosting on that streaming source device 101. The connection request message 208 may include a unique ID of the streaming source device 101, the name or other identifier of the selected video game, IP address, connection port, and any other connection information for the streaming sink device 107. The connection message is generated based on the user input, i.e. signals received from the input device(s) 218, and encoded by the processor 432 and then passed to the communications interface 422. The communications interface 422 may transmit the connection request 208 in a series of data packets to the connection node 104 via a communications protocol. A communications interface of the connection node may receive the data packets, reassemble the connection request message 208 and pass it to a processor for decoding and use.

In step 503, the connection service 115 transmits the network connection information of the streaming source software 201 executing on the streaming source device 101 to the streaming sink software 215 executing on the streaming sink device 107. For example, a processor of the connection node 104, executing the connection service 115 may generate a message including the IP address, connection port of the streaming source device 101 and may encode this message for transmission. A communications interface of the connection node 104 may transmit the network connection information in a series of data packets via a communication protocol to the streaming sink device 107.

In step 504, the connection service 115 transmits the network connection information of the streaming sink software 215 executing on the streaming sink device 107 to the streaming source software 201. For example, a processor of the connection node 104, executing the connection service 115 may generate a message including the IP address, connection port of the streaming sink device 107 and may encode this message for transmission. The communications interface of the connection node 104 may transmit the network connection information in a series of data packets via a communication protocol to the streaming source device 101.

In various embodiments, steps 503 and 504 may be executed in parallel or asynchronously.

In step 505, the streaming source software 201 executing on the streaming source device 101, transmits a connection request to the streaming sink software 215 executing on the streaming sink device 107, based on the network connection information received from the connection node 104. For example, the processor 430 may, upon decoding the network connection information received from the connection node 104, receive instructions from the streaming source software 201 to generate a peer connection request. The peer connection request may be encoded and then transmitted by the communications interface 420 to the streaming sink device 107 to establish a connection.

In step 506, the streaming sink software 215 operating on the streaming sink device 107, transmits a connection request to the streaming source software 201 executing on the streaming source device 101, based on the network connection information received from the connection node 104. The connection request contains authentication information for the user associated with the request. For example, the processor 432 may, upon decoding the network connection information received from the connection node 104, receive instructions from the streaming sink software 215 to generate a peer connection request. The peer connection request may include user credentials, tokens, or other means of authenticating the user 213, and may be encoded and then transmitted by the communications interface 422 to the streaming source device 101 to establish a connection.

In various embodiments, steps 505 and 506 may be executed in parallel or asynchronously.

In various embodiments, the streaming source software 201 and, or the streaming sink software 215 may authenticate one another based on information provided in the connection request message. This may include the use of the unique ID of the streaming source device 101, the user credentials or authentication token of the streaming sink device 107 or other information passed in the network connection messages. Various techniques for authenticating peer devices may be used to ensure that both user computing devices are authorized to connect via the peer to peer network. If the connection requests are accepted, based on the authentication, the method 500 may proceed to step 507.

In step 507, the streaming source software 201 executing on the streaming source device 101 and the streaming sink software 215 executing on the streaming sink device 107 establish a peer to peer network connection 302. The connecting user computing devices may communicate with one another via the connection ports specified in the connection request. That is, data packets streamed from the streaming source device 101 to the streaming sink device 107 may be accepted at the connection port specified by the streaming sink device 107 in its connection request transmission. Similarly, input data 406 transmitted to the streaming source device 101 from the streaming sink device 107 may be received at the connection port of the streaming source device 101 specified in the device's connection request message. Once the network connection 302 is established between the two peer devices, data can be streamed directly without requiring intervention by the connection node 104 or other intermediary.

In step 508, the streaming sink software 215 executing on the streaming sink device 107 may transmit a game launch request message to the streaming source software 201 executing on the streaming source device 101. For example, the input signals received from the input device(s) 218 as a selection of a video game from the list of video games may be used by the processor 432 to generate a game launch request message indicating the video game the user would like to play. The streaming sink software 215 may instruct the processor 432 to generate the game launch request message including an identifier of the video game indicated by the user input and may pass the message to the communications interface 422. The game launch request message may be transmitted in data packets over the network connection 302 to the streaming source device 101.

Upon receiving the game launch request message, the streaming source device 101 may launch the video game process 301. For example, the communications interface 420 of the streaming source device 101 may receive the game launch request message. The processor 430 may decode the game launch request message and under instruction by the streaming source software 201, may use the information in the game launch message to identify a video game stored in memory 440. The processor 430 may then initiate launch or execution of the identified video game. The launch of the video game may be the execution of a video game process 301, which may generate video data 404 and audio data 405 required to render the video game on the streaming sink device 107.

In various embodiments, steps 509 and 510, as well as steps 511 and 512 are executed in parallel for the duration of the remote video game session.

In step 509, the streaming source software 201 requests the video data 404 and audio data 405 generated by the executing video game process 301. For example, the processor 430 executing the streaming source software 215 may encode the video data 404 and the audio data 405, generated by the video game process 301, The encoded multimedia data may be streamed by the communications interface 420 to the streaming sink device 107 via the network connection 302.

In step 510, the streaming sink software 215 requests the user's inputs to the streaming sink device 107 and transmits them to the streaming source software 201 executing on the streaming source device 101. For example, the processor 432 may, while executing the streaming sink software 215 identify signals passed from the user input device(s) 218 as user input. This user input may be provided by the user as part of video game play, via one or more input device(s) 218. The processor 432 may encode the input data 406 and pass it to the communications interface 422 which may transmit the input data 406 as data packets over a network connection.

In step 511, the streaming source software 201 receives the user's inputs and transmits them to the video game process 301. For example, the communications interface 420 of the streaming source device 101 may receive the data packets of the input data 406 over the network connection 302 and may pass the input data 406 to the processor 430. The processor 430 may decode the input data 406 and pass it as input to the video game process 301. This input data 406 may cause the video game process to make decisions, generate new video data 404 and audio data 405, etc. This new multimedia data may be encoded and transmitted in a manner substantially similar to that described with reference to that described with reference to step 509.

In step 512, the streaming sink software 215 receives the encoded video game video data 404 and audio data 405, decodes them, and renders the video data 404 and audio data 405 for the user 213 on the streaming sink device 107. For example, the communications interface 432 may receive data packets of the encoded video data 404 and audio data 405 and may pass this data to the processor 430 for decoding. The processor 422 may decode the multimedia data and as part of the streaming sink software 215 execution, may instruct the display 409 and audio device 408, e.g., speakers, to render the video data 404 and audio data 405 respectively. These processes allow the user 213 to see, hear, and interact with the video game session from the streaming sink device 107, even though the video game process 301 is executed on the streaming source device 101, which may not be co-located with the streaming sink device 107 and the user 213.

In step 513, a video game session termination request is transmitted from the streaming sink software 215 to the streaming source software 201 executing on the streaming source device 101. For example, the streaming sink software 215 may receive an indication form the processor 432 that signals were received from the input device(s) 218 indicating that user 213 wishes to terminate a video game session. The streaming sink software 215 may instruct the processor 432 to generate a termination message, which the processor 432 encodes and passes to the communications interface 422. The communications interface may transmit the termination request as data packets over the network connection 302.

The communications interface 420 of the streaming source device 101 receives the termination request and passes it to the processor 430 for decoding. The streaming source software 201 terminates the video game process 301 and closes the network connection 302 with the streaming sink device 107. The streaming source software 201 transmits a connection request to the connection service 115, and the process repeats 514.

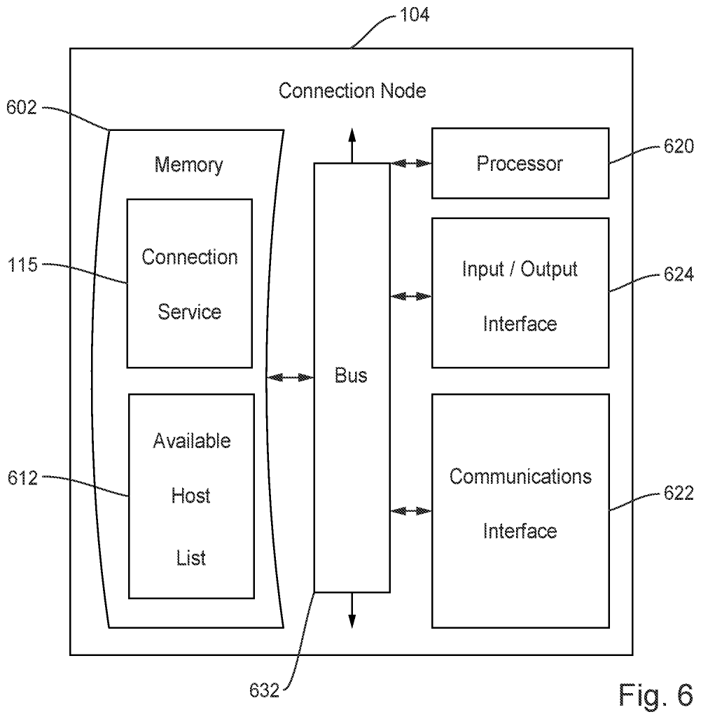

Referring to FIG. 6, a block diagram is shown illustrating a connection node of a peer to peer network. With reference to FIGS. 1-6, the connection node 104 hosts, supports, maintains, and manages a connection service 115 that facilitates connections between peer devices in a peer to peer network. The connection node 104 may include one or more servers, computing devices, and network infrastructure components configured to host the connection service 115.

The content connection node 104 includes a processor 620 coupled to a memory 602, which may include both volatile and non-volatile memory, such as a solid state, or disk drive. The connection node 104 may also include a floppy disc drive, compact disc (CD) or DVD disc drive coupled to the processor 620. The connection node 104 may also include communications interface(s) 622 coupled to the processor 620 for establishing data connections with a network. An input/output (I/O) interface 624 may include output circuitry configured to present data and input circuitry configured to receive local user input. The various components of the connection node 104 may be communicatively coupled via a system bus 632.

The memory 602 may be a computer-readable storage medium and may store a connection service 115 among other data components and applications. The connection service 115, an available host list 612 may be a software application, application programming interface, or combination thereof. The connection service 115 may receive various connection requests form user computing devices seeking peer to peer connections for the purposes of hosting or playing a video game. The connection service 115 receives from the processor 620, game host requests received by the communications interface 622. The connection service 115 may determine the unique ID of potential host devices, as well as video games the host is willing to stream. This information is added by the processor 620 executing the connection service 115, to the available host list 612. As connection requests from the user computing devices would be video game players, the connection service 115 instructs the processor to retrieve the list of available hosts 612 and pass it to the communications interface 622 for transmission along with the associated video games to be hosted by each host on the list. The connection service 115 also receives user selections from the processor 620, received by the communications interface 622. These selections are made by users 213 of a user computing device acting as a streaming sink device 107. The connection service 115 matches the user selection with a host in the available hosts list 612 and provides connection information for the selected host to the processor. The processor 620 obtains connection information for the selected host by reviewing the connection information for an open session between the host and the communications interface 622. The processor 620 uses this information to provide connection information to the streaming sink device 107. Similarly, the connection service 115 instructs the processor 620 to generate connection information about a connection to the streaming sink device 107 and transmits this to the host, a user computing device acting as a streaming source device 101.

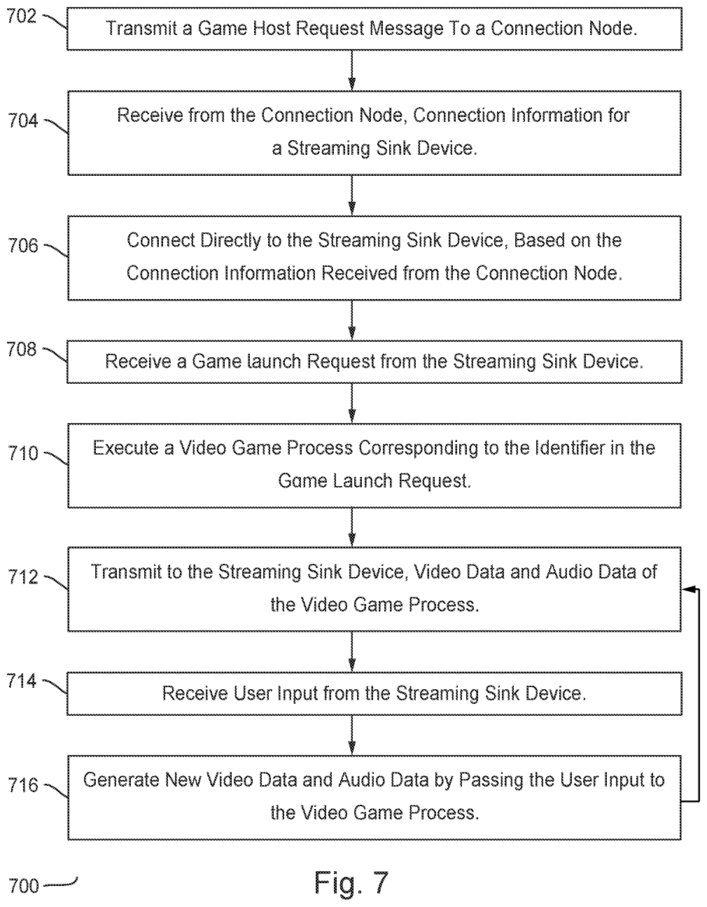

FIG. 7 shows a process flow diagram of an exemplary method 700 of hosting a streamed video game session by a streaming source device according to an embodiment of the invention. With reference to FIGS. 1-7, the streaming source device 101 may form a peer to peer network connection 302 with a streaming sink device 107 and may stream multimedia data associated with a video game process 301 to the streaming sink device 107.

In step 702, the communications interface of the streaming source device may transmit a game host request message to a connection node, wherein the game host message includes identifiers of video games the streaming source device can stream. For example, the communications interface may transmit a game host message as a series of data packets according to a communication protocol. The game host message may be generated by the processor of the streaming source device and may include information about the video game data files stored in a memory of the device. That is, the video games that the streaming source device is capable of hosting/streaming.

In step 704, the communications interface of the streaming source device may receive from the connection node, connection information for a streaming sink device. For example, the communications interface may receive a message in the form of data packets, in which the message indicates the connection information for a streaming sink device that has indicated an interest in streaming on the video games the streaming source device is capable of streaming. This network connection information may include an IP address or other network address of the streaming sink device as well as a connection port of the streaming sink device.

In step 706, the communications interface of the streaming source device may connect directly to the streaming sink device, based on the connection information received from the connection node. For example, the communications interface may transmit to the IP address or network address of the streaming sink device, a connection request directly to the streaming source device, requesting a connection via the specified connection port. In various embodiments, the streaming source device may maintain network connections with multiple streaming sink devices at the same time. This may enable the streaming of different video games to different streaming sink devices.

In step 708, the communications interface of the streaming source device may receive a game launch request from the streaming sink device, wherein the game launch request indicates an identifier for one of the video games the streaming source device can stream. For example, the communications interface may receive data packets of a game launch request message that indicates a video game that the user of the streaming sink device would like to play. The message may include an identifier of a video game for which game data exists in memory of the streaming source device. This game launch message may initiate the beginning of a video game session.

In step 710, the processor of the streaming source device may execute a video game process corresponding to the identifier in the game launch request. For example, the processor may generate one or more process threads via the streaming source software to initiate execution of a video game process associated with video game data stored in memory. The video game process may be managed by the streaming source software or run independently. The video game process may correspond to the identifier of the video game included in the game launch request message. In various embodiments, the streaming source device may host and stream multiple streams of video game data associated with multiple video game processes executing on the device.

In step 712, the communications interface of the streaming source device may transmit to the streaming sink device, video data and audio data of the video game process. For example, the communications interface may continuously transmit multimedia data generated by the video game process to the streaming sink device. This data may be continuously streamed over a peer to peer connection in a flow of data packets. Each connected streaming sink device may have its own data stream of multimedia data generated by an associated video game process. The video data may be images, video frames, etc. The audio data may be synchronized to match or correspond to the video frames or images.

In step 714, the communications interface of the streaming source device may receive user input from the streaming sink device. For example, the communications interface may receive data packets of user input from the streaming sink device. The user input data may be passed by the processor to the video game process for use in decision-making, multimedia generation, etc.

In step 716, the processor of the streaming source device may generate new video data and audio data by passing the user input to the video game process. For example, the processor may generate new video data and audio data based on the user input data. This new multimedia data may be transmitted by returning to step 712.

At the end of a video game session, the streaming source device may receive a request to terminate the peer to peer network connection. The communications interface may close a connection port over which it hosts the connection to the streaming sink device. The process can then return to step 702 and begin again.

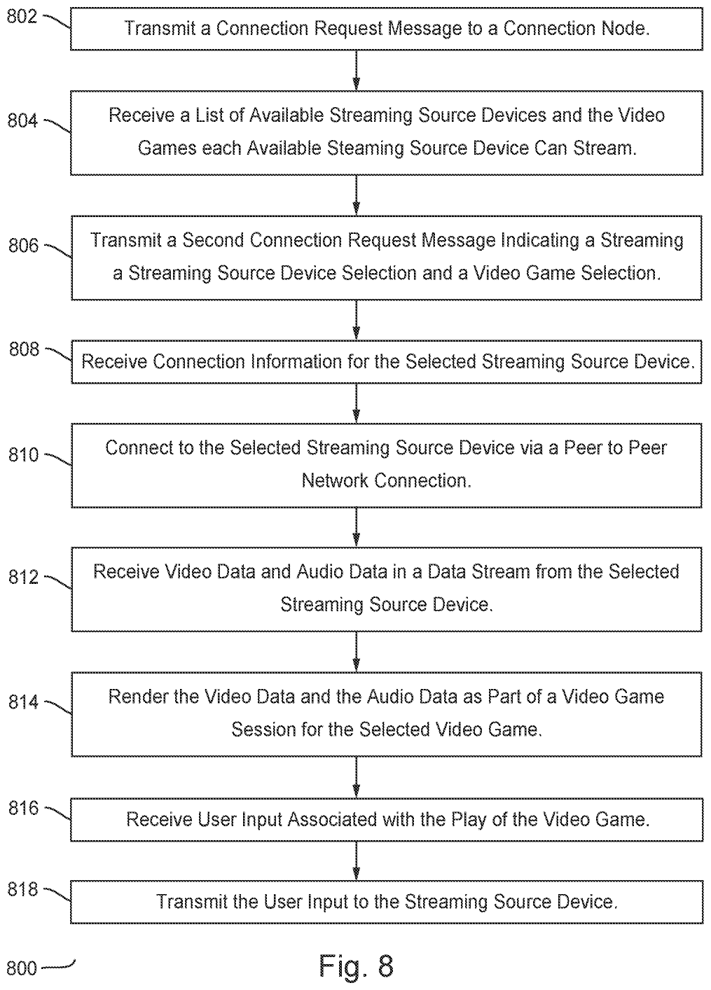

FIG. 8 shows a process flow diagram of an exemplary method 800 of playing a streamed video game session over a peer to peer network device according to an embodiment of the invention. With reference to FIGS. 1-8, the streaming sink device 107 may form a peer to peer network connection 302 with a streaming source device 101 and may receive a data stream of multimedia data associated with a video game process 301 for remote play on the streaming sink device 107.

In step 802, the communications interface of the streaming sink device may transmit a connection request message to a connection node. For example, the communications interface may transmit a connection request to the connection node, indicating that the streaming sink device would like to begin a video game session.

In step 804, the communications interface of the streaming sink device may receive a list of available streaming source devices and the video games each available streaming source device can stream. For example, the communications interface may receive data packets associated with a list of available hosts, i.e., streaming source device, to which the connection node can facilitate a peer to peer network connection. The list of available hosts may also include video games that those hosts are capable of streaming. The list of available hosts may be rendered on the display of the streaming sink device as a prompt for a user to provide input. The user may use input device(s) to select a streaming source device that offers a video game which the user is interested in playing. This list of available hosts may include unique IDs of each streaming source device on the list. The unique IDs may not be visible to the user via the displayed list.

In step 806, the communications interface of the streaming sink device may transmit a second connection request message indicating a streaming source device selection and a video game selection. For example, the communications interface may transmit a connection request in data packets according to a communication protocol to the connection node. The connection request may indicate the unique ID of a streaming source device from which the streaming sink device would like to stream a video game session.

In step 808, the communications interface of the streaming sink device may receive connection information for the selected streaming source device. For example, the communications interface may receive network connection information for the selected streaming source device. The network connection information may include an IP address, or other network address, as well as a connection port of the streaming source device that is available to host a peer to peer network connection.

In step 810, the communications interface of the streaming sink device may connect to the selected streaming source device via a peer to peer network connection. For example, the communications interface may use the received IP or network address and connection port to connect directly to the selected streaming source device. That is, the communications interface may form a peer to peer network connection between the streaming sink device and the streaming source device. As part of this connection, the streaming sink device may generate and transmit a game launch request message indicating a video game that the user would like to stream from the streaming source device.

In step 812, the communications interface of the streaming sink device may receive video data and audio data in a data stream from the selected streaming source device. For example, the communications interface may receive multimedia data generated by the video game process executing on the streaming source device. The streaming sink device may pass this multimedia data to the processor which may use it as part of executing a video game on the streaming sink device.

In step 814, the display and speaker of the streaming sink device may render the video data and the audio data as part of a video game session for the selected video game. For example, the display of the streaming sink device may be instructed or signaled by the processor to render the received video data. At the same time, the speaker may be instructed or signaled by the processor to produce audio based on the audio data.

In step 816, the input device of the streaming sink device may receive a user input associated with play of the video game. For example, the input device(s) may detect user input in the form of signals, e.g., mouse clicks, touches to a touch screen, key depressions, etc. The input data may be a user indication of preferred choices for game play, such as moving a character, selecting an object, changing scenery or settings, and the like.

In step 818, the communications interface of the streaming sink device may transmit the user input to the streaming source device. For example, the processor may pass this input data to the communications interface, which may transmit it in data packets over the peer to peer network connection to the streaming source device. This input data may be used by the streaming source device as input for the video game process. The streaming source device may receive new video data and audio data over the data stream in response to the user input data. This process may continue throughout the video game session.

When the user is done with the video game session, they may provide user input indicating a desire to terminate the video game session. The processor may receive this input from the input device(s) and may pass it to the communications interface for transmission to the streaming source device. The streaming sink device may close the connection port on which it hosts the peer to peer connection. If additional game play is desired, the process may return to step 802.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer, or other suitable peripheral device for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

As used herein, the use of “a,” “an,” or “the” is intended to mean “at least one,” unless specifically indicated to the contrary.

What is claimed is:

1. A system for peer to peer video game streaming including:
a connection node configured to:
receive, via a communications interface, connection requests from streaming sink and streaming source devices;
receive, via a communications interface, a selection of a streaming source device from a streaming sink device;
transmit, via a communications interface, the network connection information of the streaming sink device to the selected streaming source device; and
transmit, via a communications interface, the network connection information of the selected streaming source device to the streaming sink device.
a streaming sink device comprising:
transmit, via the communications interface, a connection request message indicating a selection of a streaming source device and a video game selection;
receive, via the communications interface, connection information for the selected streaming source device;
connect, via the communications interface, to the selected streaming source device via a peer to peer network connection;
receive, via the communications interface, graphics data and audio data in a data stream from the selected streaming source device; and
render, by the display and the speaker, the graphic data and the audio data as part of a video game session for the selected video game.
a streaming source device configured to:
transmit, via a communications interface, a game host request message to the connection node, wherein the game host message includes identifiers of video games the streaming source device can stream;
receive, via the communications interface, from the connection node, network connection information for a streaming sink device;
connecting, via the communications interface, directly to the streaming sink device, based on the network connection information received from the connection node;
execute, by a processor, a video game process; and
transmit, via the communications interface, to the streaming sink device, graphics data and audio data of the video game process.

2. The system of claim 1, in which the connection node is further configured to receive connection request from multiple streaming source and multiple streaming sink devices.

3. The system of claim 1, wherein the connection node is configured to:
store, in a memory, a list of available hosts including all streaming source devices for which a connection request has been received.

4. The system of claim 1, wherein the list of available hosts also includes video games that can be hosted by each streaming source device.

5. The system of claim 1, wherein the connection node is further configured such that it does not communicate with the streaming source device or the streaming sink device after the peer to peer network connection between the streaming source device so and streaming sink device is established for the duration of a video game session.

6. A user computing device for hosting a video game streaming session in a peer to peer network comprising:
a communications interface;
a processor;
a memory coupled to the processor and having stored thereon, processor-executable instructions for performing the operations of:
transmitting, via the communications interface, a game host request message to a connection node, wherein the game host message includes identifiers of video games the streaming source device can stream;
receiving, via the communications interface, from the connection node, network connection information for a streaming sink device;
connecting, via the communications interface, directly to the streaming sink device via a peer to peer network connection, based on the network connection information received from the connection node;
receiving, via the communications interface, a game launch request from the streaming sink device, wherein the game launch request indicates an identifier for one of the video games the streaming source device can stream;
executing, by the processor, a video game process corresponding to the identifier in the game launch request; and
transmitting, via the communications interface, to the streaming sink device, graphic data and audio data of the video game process.

7. The user computing device of claim 6, wherein the processor is further configured to execute operations comprising:
receiving, via the communications interface, user input from the streaming sink device, wherein the user input is associated with play of the selected video game on the streaming sink device;
passing, by the processor, the user input to the video game processor; and
transmitting, via the communications interface, to the streaming sink device, updated graphic data and updated audio data of the video game process generated based on the user input.

8. The user computing device of claim 6, wherein the processor is further configured to execute operations comprising:
receiving, via the communications interface, a connection termination request from the streaming sink device; and
terminating, by the communications interface, the peer to peer network connection with the streaming sink device.

9. The user computing device of claim 6, and further configured to maintain peer to peer network connections with multiple streaming sink devices at the same time.

10. The user computing device of claim 9, and further configured to execute a different video game process for each of the connected streaming sink devices.

11. The user computing device of claim 6, wherein the streaming source device is not co-located with the streaming sink device.

12. The user computing device of claim 6, wherein the graphics data is a plurality of video frames generated during execution of the video game process, and wherein the audio data is synchronized/associated with the graphics data.

13. The user computing device of claim 6, and further configured to store multiple video game files supporting multiple video game processes in the memory.

14. A method of hosting a streamed video game session of a peer to peer network, comprising:
transmitting, via a communications interface or a streaming source device, a game host request message to a connection node, wherein the game host message includes identifiers of video games the streaming source device can stream;
receiving, via the communications interface, from the connection node, network connection information for a streaming sink device;
connecting, via the communications interface, directly to the streaming sink device via a peer to peer network connection, based on the network connection information received from the connection node;
receiving, via the communications interface, a game launch request from the streaming sink device, wherein the game launch request indicates an identifier for one of the video games the streaming source device can stream;
executing, by the processor of the streaming source device, a video game process corresponding to the identifier in the game launch request; and
transmitting, via the communications interface, to the streaming sink device, graphic data and audio data of the video game process.

15. The method of claim 14, further comprising:
receiving, via the communications interface, user input from the streaming sink device, wherein the user input is associated with play of the selected video game on the streaming sink device;
passing, by the processor, the user input to the video game processor; and
transmitting, via the communications interface, to the streaming sink device, updated graphic data and updated audio data of the video game process generated based on the user input.

16. The method of claim 14, further comprising:
receiving, via the communications interface, a connection termination request from the streaming sink device; and
terminating, by the communications interface, the peer to peer network connection with the streaming sink device.

17. The method of claim 14, wherein the streaming source device is further configured to maintain peer to peer network connections with multiple streaming sink devices at the same time.

18. The method of claim 17, wherein the streaming source device is configured to execute a different video game process for each of the connected streaming sink devices.

19. The method of claim 14, wherein the streaming source device is not co-located with the streaming sink device.

20. The method of claim 14, wherein the graphics data is a plurality of video frames generated during execution of the video game process, and wherein the audio data is synchronized/associated with the graphics data.
